(19) United States
(12) Patent Application Publication
(10) Pub. No.: US 2014/0034476 A1
(43) Pub. Date: Feb. 6, 2014

(54) PURIFICATION OF WATER BY HEATING WITH SUNLIGHT, VIA OPTICAL CABLE

(71) Applicant: Rolf Ljunggren, Sollentuna (SE)

(72) Inventor: Rolf Ljunggren, Sollentuna (SE)

(73) Assignee: H2DO AB, Sollentuna (SE)

(21) Appl. No.: 13/982,029

(22) PCT Filed: Dec. 28, 2011
(86) PCT No.: PCT/SE11/51598

§ 371 Date: Oct. 11, 2013

(30) Foreign Application Priority Data
Dec. 29, 2010 (SE) 1051389-3

(51) Int. Cl. C02F 1/14; E21B 43/38

(52) U.S. Cl. CPC C02F 1/14; E21B 43/38
USPC 203/10; 202/166; 166/265

(57) ABSTRACT

Method and device (100) for purifying and bringing water up from a water body (50), the device including:
a hollow, vertical structure, having a first space (110) with a supply opening (112) for water to be purified;
a boiling device (111) for such water which is driven with light from an optical fiber (12);
a condenser (133) for condensing water vapour from the boiling device;
a container (131) for condensed water, which container is connected to the condenser; and
a conduit device (120) for water vapour between the space and the condenser. The space communicates freely with the water body. The outlet of the container is arranged above a heating location in the boiling device.

The present invention relates to a device and a method for purifying water and transporting water from a position in a body of water to a desired delivery place at a higher altitude. More specifically, the invention relates to such purification and transport using solar energy.

In order to produce water for drinking, irrigation and the like, water must often be desalinated and/or purified from infectious agents and other contaminations. In many situations and at many locations where such needs are present, there is no reliable source of electrical power. Examples include small-scale use in developing countries, at sea or in isolated islands. Also, it is often desirable to use renewable energy sources rather than electrical energy, often originating from fossil fuel fired power plants, etc. Therefore, there is a need to purify water using solar energy.

One way to perform such purification is to use solar cells for producing electrical energy, which thereafter drives a conventional desalination and/or purification plant, for example osmosis based. Such methods suffer from low efficiency, partly because of high losses in conventional solar cells. Moreover, such equipment is generally complicated, resulting in high purchasing costs and expensive maintenance, in turn limiting the areas of use.

Another way which has been proposed is to use a floating boiling device of the type described in U.S. Pat. No. 3,960,668, wherein a cover comprising a boiling vessel is immersed into a water body, and wherein the boiling vessel is heated using sunlight, which is focused onto the vessel using a lens arranged above the surface of the water. The evaporated steam is then led to a condenser, in which it is collected in the form of condensed, distilled water.

Such a device needs the water to be purified to be pumped into the vessel, that residual water is pumped out from the vessel, and that purified water is pumped out from the container for condensed water. Also, various venting tubes and other peripheral equipment are required. Therefore, such a device is relatively complicated and expensive, requires much maintenance and also a reliable source of electricity for driving the equipment. The angle of the lens in relation to the sun is variable, since it heels in the water, resulting in that the light cannot be focused at one and the same point over time. Furthermore, the device is exposed to the elements in its position near the surface of the water, whereby splashes of water and residues will limit the amount of light which can be focused onto the boiling vessel. Finally, the efficiency of such a boiling device is relatively low, since large amounts of energy are required to heat the water from the ambient temperature in the water body to the boiling point.

The present invention solves the above described problems.

Hence, the invention relates to a device for purifying water, comprising a hollow structure in turn comprising a first space, comprising a supply opening for water to be purified and a boiling device for such water, arranged to heat the water to the boiling point using energy from focused sunlight which is supplied via a supply device for sunlight to a certain heating location in the first space; a condenser for condensing water vapour from the boiling device; and a conduit device for water vapour, arranged to bring water vapour from the first space to the condenser, and is characterised in that a heat exchanger is arranged to transfer thermal energy from either hot water vapour which has been boiled off in the boiling device or condensed water which is still warm and originates from such vapour, to water to be purified and which is to be introduced into the first space through the supply opening.

In the following, the invention will be described in detail, with reference to exemplifying embodiments of the invention and to the enclosed drawings, where:

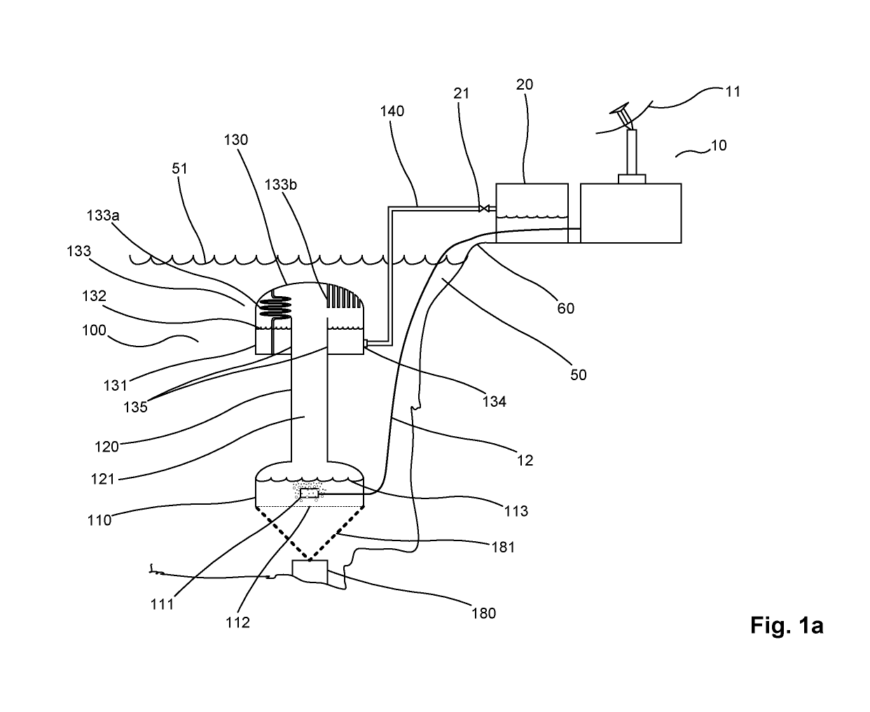

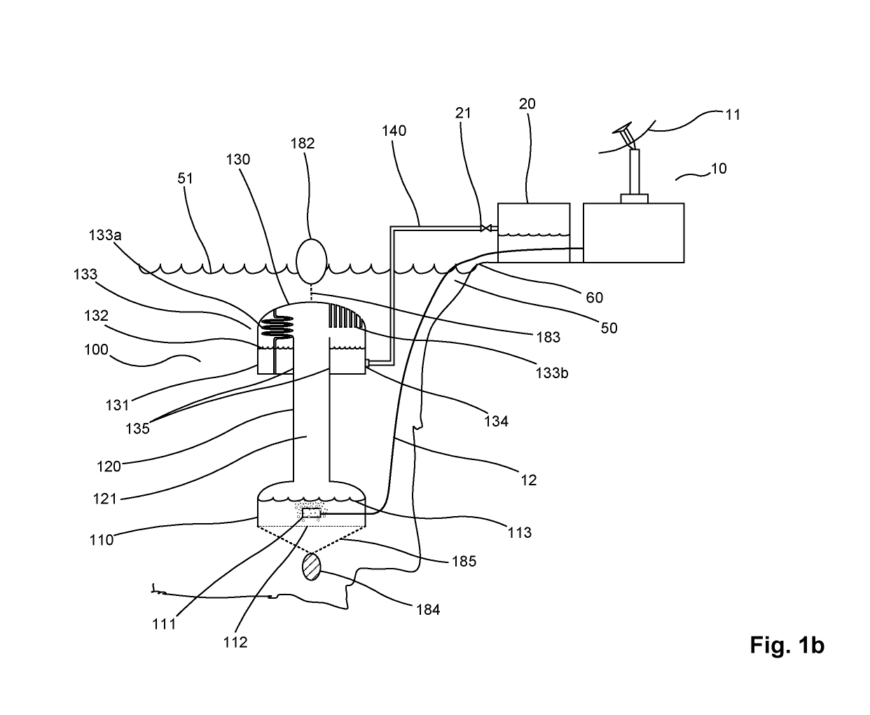

FIG. 1a is an explanatory sketch of a first device for purifying and transporting water according to the invention, which device is firmly established to a bottom;

FIG. 1b is an explanatory sketch of the device according to FIG. 1a, but where the device floats on a surface;

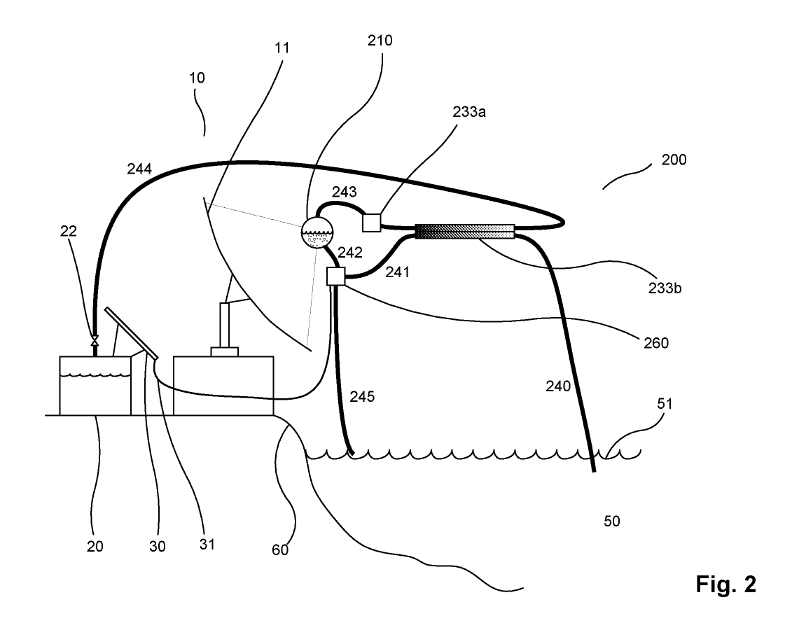

FIG. 2 is an explanatory sketch of a second device for purifying and transporting water according to the invention, comprising a boiling vessel onto which light is focused as well as a heat exchanger;

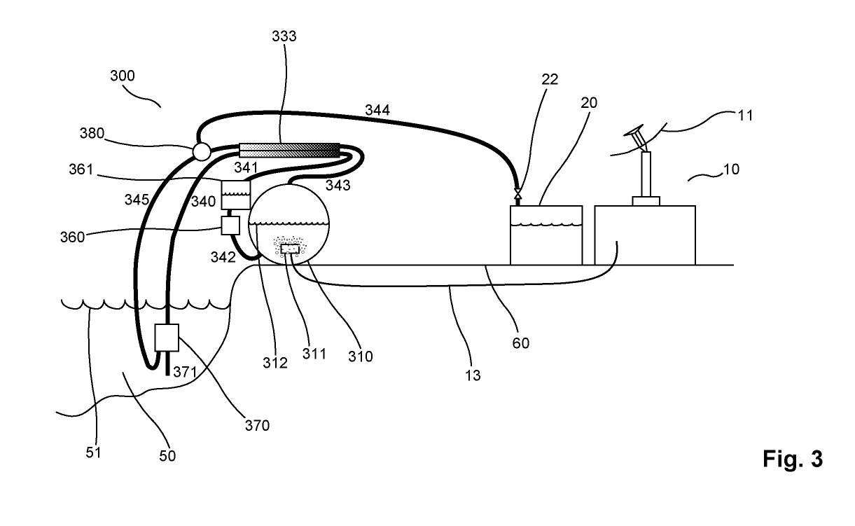

FIG. 3 is an explanatory sketch of a third device for purifying and transporting water according to the invention, comprising a boiling vessel and a heat exchanger;

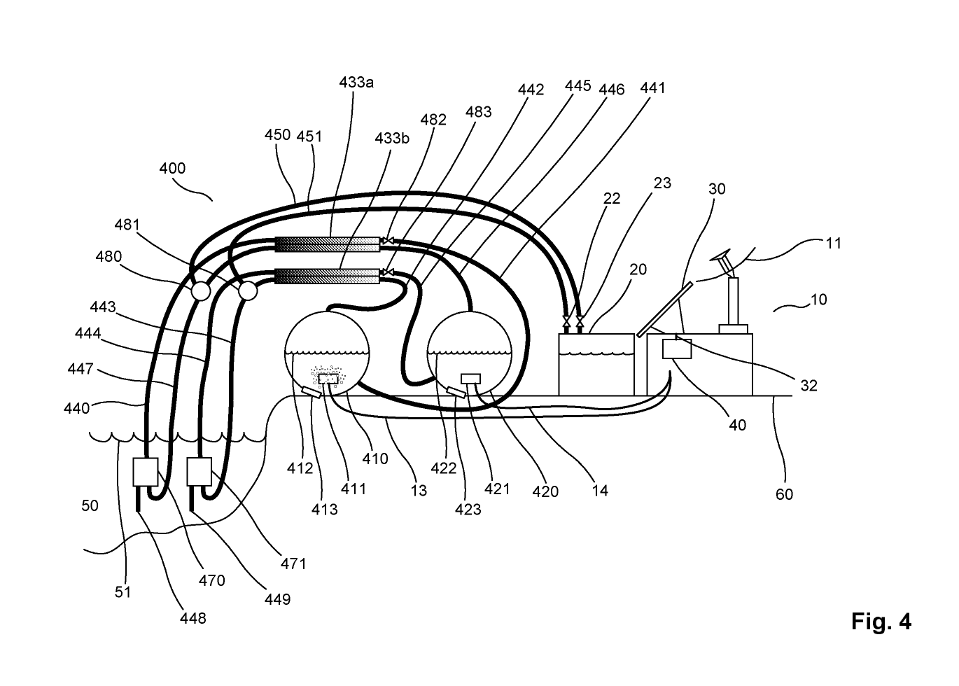

FIG. 4 is an explanatory sketch of a fourth device for purifying and transporting water according to the invention, comprising two boiling vessels and two heat exchangers;

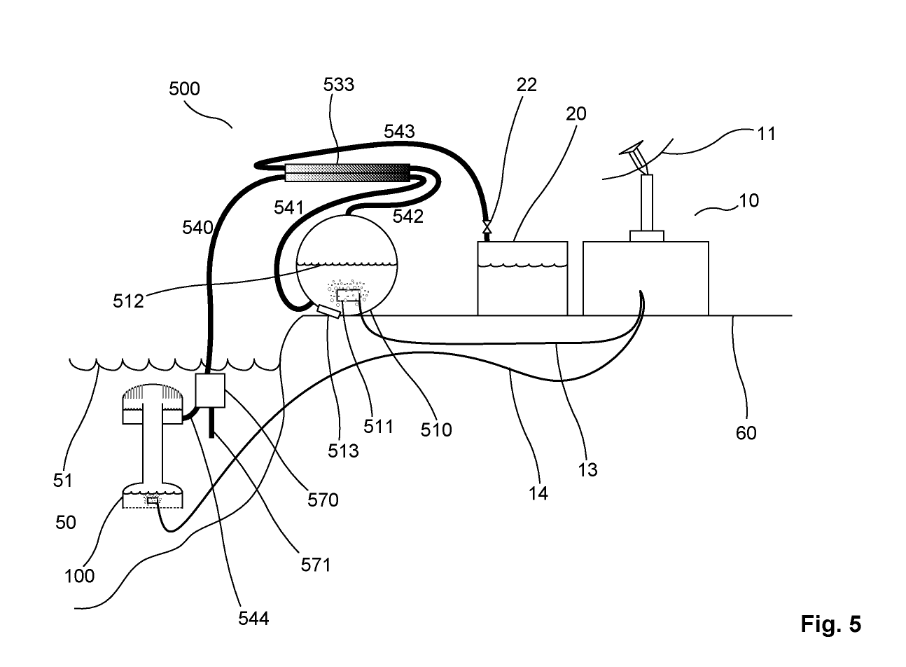

FIG. 5 is an explanatory sketch of a fifth device for purifying and transporting water according to the invention, comprising a device according to FIG. 1, a boiling vessel and a heat exchanger; and

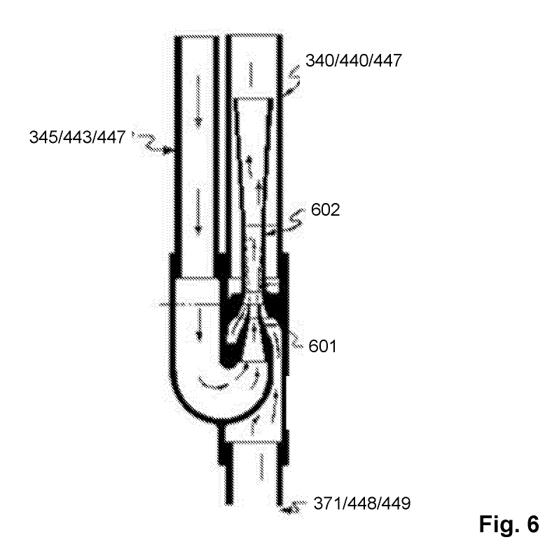

FIG. 6 shows an aspirator according to the invention.

All figures share the same reference numbers for corresponding details.

FIGS. 1a and 1b illustrate a device 100 for purifying water and transporting the purified water from its original location as a part of a body 50 of non-purified water up from the water body 50. The device 100 comprises a hollow structure, which in turn comprises a boiling space 110, an elongated conduit device 120 as well as an upper part 130. It is preferred that the conduit device 120 is in the form of a hollow cylinder, which connects the boiling space 110 to the upper part 130, so that these two parts freely can communicate with each other. Herein, that the two spaces “freely can communicate” with each other is to be interpreted so that gas and liquid can flow freely between the spaces without any intermediate obstacles.

During operation, the device 100 is positioned at least partly, preferably completely, immersed into the water body 50, as illustrated in FIGS. 1a and 1b, in an upright operating position in which water vapour, according to a preferred embodiment, can rise essentially straight upwards in the conduit device 120 from the boiling space 110.

The boiling space 110 comprises a supply opening 112 for not yet purified water from the water body 50. Furthermore, there is a boiling device 111 in the boiling space 110, arranged to heat non-purified water at a certain heating location in the space 110 to its boiling point, so that sufficient amounts of vapour depart from this water.

It is preferred that the boiling space 110 is in the form of a hood shaped structure which is open from beneath, so that sufficient amounts of water can be turned over in the boiling space 110 via self circulation. This results in that water with high concentrations of contaminants, after this water has been partly boiled off, can be diluted with additional non-purified water without having to perform mixing in some other way than self circulation. At the same time, it is preferred that the heating location is arranged above the supply opening 112, so that power losses in the form of too large dilution of the heated water which has not yet evaporated are avoided.

The boiling device 111 receives its energy from a fiber optical cable 12, which during operation conveys light from a light focusing device 10 above ground 60, and thereby also above the surface 51 of the water body 50, to the boiling device 111. The light focusing device 10 comprises a mirror 11, which is conventional as such and arranged to focus sunlight from a larger surface and lead this light into the fiber 12. For instance, the device 10 may comprise a parabolic main reflector and a smaller secondary reflector, which latter is arranged to direct the light beams reflected by the main mirror into the fiber end. It is preferred that the surface from which incident sunlight is focused is at least 10 m². This way, a sufficient light power can be brought through the fiber 12 and up to the boiling device 111 in order to achieve sufficiently intense boiling of the water in the space 110 in order to achieve the present purposes.

The boiling device 111 can exploit the solar energy in order to heat the water in a way which is conventional as such, for example by directing the incident light onto a black body in the space 110, which this way is heated and indirectly heats the water.

The boiling space 110 is open upwards to the conduit device 120, so that vapour which has departed from the boiling process can rise upwards through the conduit device 120 and onwards to the upper part 130. The latter comprises a condenser 133 for condensing water vapour from the boiling device.

In both FIGS. 1a and 1b, the device 100 is shown with two different illustrated types of condensers 133. It is realized that either of these, or a combination, and/or other types of condensers may be used. However, it is preferred that the condenser 133 is arranged to condense water vapour to liquid state by cooling using the non-purified water in the surrounding water body 50. The simplest way to achieve this is that the condenser 133 during operation is immersed below the surface 51 of the water body 50.

A first example of a useful condenser 133 is thus a conduit system 133a which runs, isolated from the water vapour and the condensed water, through the upper part 130, through which conduit system 113a non-purified water flows by aid of self circulation as a consequence of temperature gradients in the upper part 130 during operation.

A second example is constituted by a series of flanges 133b that either accommodate non-purified water which is isolated from the water vapour and the condensed water, or is thermally connected to such water.

The condenser 133 is connected to, and communicates freely with, a container 131 for condensed water, arranged to collect the water which is condensed using the condenser 133. Hence, the conduit device 120 and the container 131 for condensed water are designed so that a channel for water vapour runs from the boiling space 110 to the container 131, via the condenser 133 so that the space 110 can communicate freely with the container 131. It is preferred that the cooling means of the condenser 133, such as its cooling flanges 133b, are positioned in and along this channel, either above or inside the container 131.

As is illustrated in FIGS. 1a and 1b, according to a preferred embodiment the above mentioned channel runs firstly upwards through the conduit device 120 and then again downwards to the container 131. This latter is achieved according to the illustrated embodiment using an essentially vertical partition wall 135 between the upper part of the conduit part 120 and the container 131, in combination with a tight ceiling in the upper part 130. The container 131, preferably the whole container 131, is preferably arranged at a higher altitude than the boiling space 110.

Using such a construction, condensed water can be collected in the container 131 without leaking back down through the conduit device 120.

The container 131 is arranged with an exit 134 for condensed water, during operation arranged below a liquid level 132 in the container 131.

During operation, the device 100 is positioned at least partly immersed into the water body 50, with the boiling space 110 downwards. In this position, the space 110 will thus freely communicate with the water body 50. Furthermore, the above mentioned structure, except the supply opening 112 for non-purified water and the outlet 134 for condensed water, is arranged to be closed during operation. In other words, the structure, except for the outlet 134, consists of a container which is upwards gas- and liquid tight, which container can retain a volume of gaseous water vapour even when the structure is immersed into the water body 50.

Moreover, during operation the outlet 134 is arranged above the heating location in the boiling space 110.

During operation, the device 100 is thus positioned immersed into the water body 50, whereby non-purified water flows into the device 100 via the opening 112. It is preferred that the outlet 134 is kept tight when the device 100 is immersed into the water body 50, so that a certain volume atmospheric air is retained in the container at the start of the operation. Thereafter, the boiling is commenced by supplying light energy to the boiling device 111.

Hence, the water vapour departing from the non-purified water in the space 110 flows upwards to the conduit device 120 and the upper part 130. Condensed water is collected in the container 131. Thereby, during operation in an equilibrium state a gas column 121 is maintained in the structure, which essentially consists of water vapour and which is limited by the water surface 132 in one of its ends and a water surface 113 in the space 110 in its other end. During operation, it is possible to, via a suitable control of supplied light energy and/or discharge of condensed water via the outlet 134, achieve a stable level for the water surface 113, above the heating location.

Since the heating location is arranged below the outlet 134, such a stable water level 113 in the space 110 can also be arranged below the outlet 134. As a consequence, the water pressure from the surface 113 against the gas column within the hollow structure, in combination with the steam pressure therein arisen as a consequence of boiling, will give rise to an overpressure in the hollow structure. This overpressure will also prevail in the condensed water in the container 131 and be available at the outlet 134.

From the outlet 134, the condensed water will be led to a desired delivery location above ground, in FIGS. 1a and 1b illustrated in the form of a tank 20 for purified water. Since the water is then distilled, it is also purified from for instance particles and salts. Moreover, the boiling results in that any microorganisms can be killed off efficiently.

Moreover, there is no need for an external pump to transport the purified water up to the tank 20, from the outlet 134 which is arranged at a lower altitude. Instead, according to a preferred embodiment only the above explained self pressure is used. It is preferred that the height difference between, on the one hand, the heating location, and therefore the water surface 113, and, on the other hand, the outlet 134, and therefore also the height of the above-mentioned gas column 121, is selected to be sufficiently large in order for the resulting self pressure to be enough to press the purified water up to the tank 20.

It is preferred that the outlet 134 is arranged to open out below the surface 51 of the water body 50. This maximizes the available self pressure, at the same time as it facilitates for the condenser 133 to be arranged below the water surface 51, which also simplifies the condensing of the water vapour.

A valve 21 along the conduit 140 is arranged to, in closed position, maintain the pressure in the device 100 during operation and to, when needed, in open position, instead let purified water be delivered to the tank 20. It is realized that only so much water can be tapped off from the container 131 so that the outlet 134 still is arranged completely below the water surface 132. If no tapping takes place, the water in the container 131 will overflow into the conduit device 120, why the device 100 is self-regulating.

According to a preferred embodiment, illustrated in FIGS. 1a and 1b, the conduit device 120 is designed as an elongated, cylindrical body, which in the operating position runs essentially vertically. The cylindrical body is, for example by aid of the upper part 130, closed at its upper end. At the same time, an opening at the upper part of the cylindrical body admits that water vapour is led from the boiling space 110 to the container 131. This results in an uncomplicated construction.

According to an especially preferred embodiment, which also is shown in FIGS. 1a and 1b, depicting the device 100 in a cross-section, the device as a whole is essentially circular symmetric. In other words, the space 110, the conduit device 120 and the upper part 130 are all circular symmetric, and the container 131 is designed as a circular ring, which surrounds the upper part of the periphery of the conduit device 120. Preferably, the cooling means of the condenser 133 are also circular symmetric, while various smaller equipment details, such as the boiling device 111 and the outlet 134, may be non-symmetric.

Such a mainly circular symmetric disposition admits that the device 100 obtains a level distribution of weight, and therefore can be balanced in its upright position in the water 50 without requiring expensive, load redistributing construction considerations.

The device 100 is preferably made from a suitable plastic material. Since the device 100 during operation contains a certain amount of gas, it will float as a whole. Therefore, there is a need for it to be stabilized in its upright position immersed into the water 50 during operation.

FIG. 1a shows a first preferred way to achieve this, using a fixed anchoring 180 to the bottom, which retains the device 100 using chains 181 or the like.

FIG. 1b shows a second preferred way to achieve the same goal, using an anchoring buoy 182 with an appurtenant anchoring cord 183 or the like, in combination with a sink 184 with associated anchoring chains 185 or the like. It is realized that the sink 184 and/or the float 182 also may be integrated in the device 100 itself. This other way, where hence the device 100 is caused to float freely in its upright position of operation, results in an increased flexibility when positioning the device 100 during small-scale and/or temporary operation for water purification. In this case, it is essential that the total density and weight distribution of the device 100 are selected so that it can float upright and at a desired depth in the water 50.

A device 100 according to the above described can advantageously be used to achieve desalinated drinking water from sea water, only using solar energy. The purified water can then, as described above, be delivered to a desired delivery location above ground for use.

Such a device can also be lowered down into a contaminated well or the like, and thereby achieve a combined pumping up and purification of the water in the well, so that potable drinking water is achieved, delivered above ground.

FIG. 2 shows a second exemplifying device 200 according to the present invention for purification of water collected out of a body 50 of non-purified water.

Like the device 100, the device 200 comprises a hollow structure, in turn comprising a first boiling space 210 for not yet purified water, which in this exemplifying embodiment is arranged above a water surface 51 of the water body 50. The space 210 comprises a supply opening for supplying the space 210 with such water, and a boiling device for such water, which boiling device is arranged to heat the water to the boiling point using energy from focused sunlight supplied via the light focusing device 10 to a certain heating location in the boiling space. In the device 200, the space 210 itself constitutes the boiling device, and the light focusing device 10 comprises a mirror 11, arranged to reflect incident light directly towards the space 210. Either the space 210 as a whole constitutes the heating location, alternatively the space 210 comprises a black body onto which sunlight is focused. In the latter case, the area in immediate vicinity to the black body constitutes the heating location.

Furthermore, the hollow structure comprises a conduit 243, a condenser 233a, an additional conduit 244 and the tank 20 for purified water. The water vapour achieved in the space 210 is brought, using its own pressure, through the conduit 243 to the condenser 233a, which condenses the vapour to hot water, which hot water preferably holds a temperature of at least 90° C. The hot water flows on, through the conduit 244 and via the pressure controlling valve 22, to the tank 20.

Between the condenser 233a and the valve 22, the hot water passes a heat exchanger 233b, in which thermal energy contained in the hot water is transferred to not yet purified water, which has been brought to the heat exchanger 233b via a conduit 240 from the water body 50.

According to a preferred embodiment, the heat exchanger 233b is of counter-flow type, which admits that about 90% of the temperature difference between the hot water and the not yet purified water can be put to good use in the latter water. This way, the condensed water reaching the valve 22 will hold a temperature which is only a few tens of degrees Celsius above the temperature prevailing in the water body 50 at the location where water is sucked into the conduit 240. At the same time, the not yet purified water out from the heat exchanger 233b can hold at least 70° C.

This increases the efficiency of the water purification process substantially as compared to conventional technology for purification of water using solar energy, since the incoming water in the boiling device 210 only needs to be heated from the temperature it holds after the heat exchanger 233b to the boiling point.

The condenser 233a is not necessarily a discreet component, as shown in FIG. 2. Rather, the condenser 233a may be constituted by the heat exchanger 233b, or comprise the heat exchanger 233b as a subcomponent for condensing the vapour into liquid water. The transfer of thermal energy from the hot water vapour, which has been boiled off in the boiling device, to the water, which is to be purified, then contributes to, or brings about, that the vapour is condensed. Such embodiments are illustrated in FIGS. 3-5.

Moreover, condensing of the vapour can either take place upstream of, in, or downstream of the heat exchanger 233b. Thus, the heat exchanger 233b can transfer the thermal energy contents either form vapour or from liquid water or a combination of both, all depending on the current application.

The not yet purified water which has been heated in the heat exchanger 233b is brought, via conduit 241, a pump 260 and an additional conduit 242, to the boiling space 210 through its supply opening. The pump 260 is arranged to pump up the water from the water body 50 and to supply this water to the boiling space 210 under an overpressure which exceeds the pressure in the space 210 as a consequence of the pressure boiling therein, so that the supplied water can be pressed into the already pressurized space 210.

After operation during a certain time, salts, particles and/or other contaminants will accumulate in the space 210. The space 210 can then be emptied by bringing residual water out from the space 210 via the supply opening, which advantageously is arranged near the bottom of the space 210, via the conduit 242, the pump 260 and a possible tap conduit 245. Such tapping can for instance take place by the pump 260 pumping out the water from the space 210, or by a valve in the pump temporarily switching, so that the conduit 242 freely can communicate with the conduit 245.

In case a reliable source of electricity is lacking on the current location of operation, it is preferred that a solar cell device 30 or the like generates an electric voltage from incident sunlight and applies this voltage across a cable 31 which is connected to the pump 260 and/or a control device, which may be integrated in the pump, in order to control the pump and/or any valve according to the above said. The control device may in this case either switch the plant on or off, so that it is only operated during the day. Alternatively, such operation may be made self-controlling by the pump only being driven when the sun shines and the voltage therefore is present across the cable 31.

Such a system offers efficient purification of water using solar energy.

FIG. 3 illustrates another preferred embodiment of the present invention, in the form of a device 300. The light focusing device 10 comprises a mirror 11, similar to the one shown in FIGS. 1a and 1b, arranged to focus and guide sunlight into an optical fiber 13 for further transport to a boiling device 311, which is arranged in a boiling space 310 for not yet purified water. The boiling device 311 may be similar to the boiling device 111, and is arranged to heat water to be purified in the space 310 to the boiling point. The supply opening of the space 310 is arranged above the surface 51 of the body 50 of water to be purified.

Since the optical dampening in conventional optical fibers is limited, and since the focused sunlight is led from the device 10 to the boiling device 311 via such an optical fiber, increased flexibility regarding the positioning of the boiling space 310 in relation to the mirror 11 can be achieved, and the focused sunlight can be more efficiently used in the boiling process since the boiling device 310 must not be adapted as regards size or otherwise in order to be heated directly by incident sunlight.

Water vapour which has been boiled off from a water surface 312 in the space 310 departs, in a way which corresponds to the one described above, through an outlet in the upper part of the space 310, through a conduit and via a heat exchanger 333, preferably of counter-flow type, as well as a changeover valve 380, an additional conduit 344 and a pressure-controlling valve 22, to the tank 20 for purified water.

Water to be purified is led from the body 50 of not yet purified water, via a conduit 340, to the heat exchanger 333, in which thermal energy from the hot water vapour is transferred to the not yet purified water. In this exemplifying case, the heat exchanger 333 also constitutes the condenser.

A certain share, preferably less than 50%, of the condensed water, which has been pressurized by boiling and which has passed the heat exchanger 333, is led off in the valve 380 and brought, via a conduit 345, down below the surface 51 of the water body 50 and on to an aspirator pump device 370, which is supplied with not yet purified water via a supply conduit 371 and which is arranged to pump such water up to the heat exchanger 333 for heating, and further to a water tank 361 for not yet purified water. From the water tank 361, which is arranged at a higher altitude than the surface 51 of the water body 50, water to be purified is then pressed into the space 310 using a pump 360, a supply conduit 342 and the supply opening of the space 310. Since the pump device 370 lifts the water to the container 361, the pump 360 may be designed with a smaller capacity than what would otherwise have been the case.

The aspirator pump device 370 is arranged to use only the pressure difference between on the one hand the condensed water in the conduit 345, which is under overpressure because of the pressure boiling in the space 310, and on the other hand that prevailing in the existing, still not purified water in the body 50, in order to pump the latter up to the container 361.

FIG. 6 shows an example of how such a device can be designed based upon a venturi effect. The conduit 345 thus conveys the pressurized water up to a location in a nozzle 601, where it meets a stream of not yet purified water flowing through the conduit 371. It is preferred that the conduits 345, 371 are arranged as concentric tubes at the location where these two water streams meet, with the conduit 345 for the pressurized water as the inner tube. A venture tube 602 gives rise to an increased flow velocity and therefore a lower pressure, which results in that the not yet purified water in the conduit 371 is sucked into and along with the stream of condensed water from the conduit 345. This way, sufficient amounts of not yet purified water can be pumped up to higher altitude, only by using the pressure difference between the two liquid streams. Such aspirator pumps are well known in the arts, and the corresponding principle also works for using pressurized water vapour, upstream of the condenser, for pumping not yet purified water from the water body 50 up to a location above the surface 51.

Hence, this way the energy contents of the boiled off water vapour both regarding pressure and temperature can be used for increasing the efficiency for the purification process, which makes it efficient.

FIG. 4 illustrates a device 400, which constitutes an additional exemplifying embodiment of the present invention, similar to the embodiment shown in FIG. 3, but which uses two boiling spaces 410 and 420 in parallel, each comprising respective supply openings for water to be purified, respective water surfaces 412, 422 and boiling devices 411, 412, arranged to heat water to be purified to the boiling point using solar energy, delivered via a respective optical fiber 13, 14 from the sunlight focusing device 10.

From the water body 50, water to be purified is led, via a conduit 440 and a heat exchanger 433a, preferably of counter-flow type, in which thermal energy is transferred to the water to be purified from pressurized, boiled off water vapour from the second space 420, whereby this water vapour is also condensed. Thereafter, the heated, not yet purified water is led through a conduit 441 and into the first space 410 through its supply opening; in the form of therein boiled off, pressurized water vapour through a conduit 422 to a second heat exchanger 433b, also preferably of counter-flow type, arranged to transfer thermal energy from the vapour, which is thereby condensed, to water to be purified on its way to the second space 420; through a conduit 443 to an aspirator pump device 471 which is similar to the aspirator pump device 370, arranged to pump not yet purified water up from a supply 449.

The pumped up, not yet purified water, mixed together with the condensed water, is brought through a conduit 444 back through the second heat exchanger 433b in order to be heated therein, on through a conduit 445 and into the second space 420 via its supply opening. Boiled off water vapour from the second space 420 is brought through a conduit 446 to the first heat exchanger 433a, in which the vapour is cooled and condensed in order to thereafter be brought, through a conduit 447, to an aspirator pump 470, which is also similar to the aspirator pump 370 and which is arranged to, in a way which corresponds to the mode of operation for the aspirator pump 471, pump not yet purified water which is supplied via a supply 448 up to the aspirator pump 470 from the water body 50.

Switching valves 480, 481 are arranged to selectively direct a part or all condensed water from the respective conduit 447, 443 to the tank 20 for condensed water, via respective conduits 450, 451 and pressure controlling valves 23, 22.

The device 400 is operated in an alternating manner. In a first step, the first space 410 is thus operated for boiling of water to be purified, by supplying solar energy via the fiber 13. The pressurized vapour from the first space 410 is used in order to pump water to be purified up to the second space and to preheat said water, using the aspirator pump 471 and the heat exchanger 433b, which water in this first step is not heated using solar energy. Since the second space 420 in this situation is not pressurized by boiling, water can be led into the space 420 without having to use high supply pressures. At the same time, a valve 482, along the conduit 441 or in connection to the supply opening of the first space 410, can be kept in a closed position in order to create a counter-pressure for the pressure boiling in the first space 410. A certain share, preferably at least 50%, of the condensed water can be led off in the form of purified water via the conduit 451.

In a second step, both spaces 410, 420 assume roles which are analogous to the above said but opposite, and the second space 420 is heated via the fiber 14 while the first space 410 is filled with preheated, not yet purified water. The valve 482 is in this situation open, and a valve 483, which was kept open during the first step, is now kept closed in order to create a counter-pressure in the second space 420. FIG. 4 illustrates the situation during operation according to the first step.

After the second step, the first step is again resumed, so that an alternating, cyclic operation is achieved. Suitable periods for a full cycle are between 20 and 300 minutes.

In this embodiment, it is preferred that the two spaces 410, 420 comprise thermal insulation of the respective boiling space, so that the preheated water in a space will not cool down more than necessary before heating of the space in question is commenced using solar energy via the respective fiber.

In order to control the valves and which fiber which is to be active, preferably a control device 40 is used, which is supplied with electrical energy via a cable 32 from a solar cell device 30 for production of a voltage from incident sunlight. The control device 40 can also be arranged to open a respective foot-valve 413, 423 in both respective space 410, 420, for tapping off residual water from the space which is about to start being filled with not yet purified water in connection to a switch of mode of operation from one step to the other.

It is also preferred that the control device 40 is equipped with an overflow protection, preventing that too much not yet purified water is supplied to the space which is presently filled.

This way, either of the two boiling spaces 410, 420 can at all times be heated by sunlight, via a respective optical fiber 13, 14, and thereby boil water for purification. At the same time, the currently not heated space can be replenished with new, preheated water to be purified in the wake of the next heating phase. The only externally supplied energy, apart from sunlight supplied via the two fibers 13, 14, is the energy required to drive the control device 40.

FIG. 5 illustrates an additional preferred embodiment, in the form of a device 500 with only one boiling space 510 above ground 60.

The boiling space 510, which is similar to the boiling spaces 310, 410 and 420, comprises a boiling device 511, which is fed with light energy via the optical fiber 13 and which runs from the sunlight focusing device 10; a water surface 512; as well as a foot-valve 513 for tapping of residual water.

The boiled off water vapour from the boiling device 511 is led through a conduit 542, via a condenser/heat exchanger 533, which is similar to the above described heat exchangers and which preferably is of counter-flow type, an additional conduit 543 and a pressure controlling valve 22 to the tank 20 for condensed water.

A device 100 according to what has been described above in connection to FIGS. 1a and 1b is furthermore arranged at least partly immersed into the water body 50, wherein an open boiling space is arranged to boil not yet purified water using solar energy, delivered through an optical fiber 14. As described above, this gives rise to a pressurized amount of condensed water in the container of the device 100. This pressurized, condensed water is tapped from the outlet of the container, and is led through a conduit 544 to an aspirator pump 570 of the type described above in connection to FIGS. 3 and 4, which aspirator pump 570 is arranged to pump the condensed water together with not yet purified water which is sucked into the pump through an inlet 571, up through the conduit 540, via the heat exchanger 533 and an additional conduit 541 and on to and into the boiling space 510 via its supply opening. In the heat exchanger 533, thermal energy is transferred from the water vapour boiled off in the space 510, which heat exchange preheats the pumped up water as described above.

What is of importance is also that the pressure which is achieved in the conduit 541 near the supply opening of the space 510 depends on the dimensioning of the device 100 in terms of the height of its gas column, as described above, in combination with the height difference between the device 100 and the space 510, the design of the aspirator pump 570, pressure losses in conduits 544, 540, 541 as well as in the heat exchanger 533 and so on. According to a preferred embodiment, these and other parameters are selected when applying the present invention according to the current embodiment so that the available pressure at the supply opening in the conduit 541 exceeds the operation pressure inside the space 510 during operation with boiling therein. In other words, the water which is delivered through the conduit 541 will hold such a high pressure so that it can be pressed into the space 510 and thereby fill this, at the same pace as the water existing therein is vapourized. The pressure in the space 510 is controlled, as described above in connection to FIGS. 2-4, using the pressure controlling valve 22.

The flow of water to be purified to the space 510 can, when so is needed, be controlled using suitable valves along with the conduit 544 and/or in the aspirator pump 570 and/or along the conduit 540.

According to a preferred embodiment, the foot-valve 513 is controlled using a sun valve, which is conventional as such and advantageously arranged both as a part of the foot-valve 513 and to open the foot-valve when the intensity of the sunlight incident onto the sun valve decreases below a predetermined value, so that the space 510 is emptied of residual water.

Hence, this way a self-regulating system can be achieved for the production and delivery of purified, desalinated water to the tank 20 during daylight hours, which system also is automatically emptied of residual water at dusk, in order to, the next day, as solar energy delivery again is commenced through fibers 13, 14, anew be filled with water to be purified. This takes place without any externally supplied energy, except for the solar energy being captured by the mirror 11 and the sun valve. Moreover, the device 500 can be built from a minimum of movable parts, which decreases maintenance requirements of the system. Finally, it can be easily assembled from standard parts, resulting in a cost-efficient installation.

Above, preferred embodiments have been described. However, it is obvious to the skilled person that many modifications can be made to the described embodiments without departing from the idea of the invention.

For example, a device of the type described in connection to FIGS. 1a and 1b can be used as only a solar powered pump, for instance for pumping up already potable water from a well.

Moreover, a device of the type illustrated in FIG. 2 can also be supplied with not yet purified water using either a device according to FIGS. 1a and 1b, or using an aspirator pump of the type described in connection to FIGS. 3-5.

The devices illustrated in FIGS. 2-5 can, like devices according to FIGS. 1a and 1b, be used for pumping up and purifying water from wells.

Furthermore, the supplied solar energy can be used to increase the temperature of the produced water vapour to above 100° C., such as to at least 120° C. or even higher, in order to thereby achieve even better disinfection of the water.

Thus, the invention shall not be limited to the described embodiments, but may be varied within the scope of the enclosed claims.

1-15. (canceled)

16. Device (100) for purifying water and transporting the purified water from its original location as a part of a body (50) of non-purified water and up from said water body, which device comprises an elongated, hollow structure, which structure can be placed in an upright operating position in which the structure is essentially vertically arranged and in turn comprises
a first space (110), comprising a supply opening (112) for water to be purified and a boiling device (111) for such water, arranged to heat the water to the boiling point using light supplied through an optical fiber (12) to a certain heating location in the first space;
a condenser (133) for condensing water vapour from the boiling device;
a container (131) for condensed water which is connected to the condenser, comprising an outlet (134) arranged below a liquid level (132) in the container during operation of the device; and
a conduit device (120) for water vapour, connecting the upper part of the first space to the condenser so that the first space freely communicates with the container for condensed water; characterised in that the first space is arranged to freely communicate with the water body when the structure is in its operating position and at least partly immersed into the water body, in that the structure, apart from the supply opening and the outlet for condensed water, is arranged to be closed during operation, and in that the outlet of the container during operation in the said operating position is arranged above the heating location.

17. Device (100) according to claim 16, characterised in that the condenser (133) during operation is arranged to be immersed into the water body (50), and in that it is arranged to cool the water vapour using the surrounding water in the water body.

18. Device (100) according to claim 16, characterised in that the conduit device (120) and the container (131) for condensed water are designed so that, in the said upright operating position, a channel, comprising the conduit device (120), through which water vapour can be led from the first space (110) to the container (131), firstly runs upwards and then downwards to the container, which is arranged at a higher altitude than the first space.

19. Device (100) according to claim 18, characterised in that, in the said upright operating position, the condenser (133) comprises cooling means (133a; 133b), arranged in the said channel for water vapour either above or in the container (131) for condensed water.

20. Device (100) according to claim 18, characterised in that the conduit device (120) is designed as an elongated, cylindrical body, which in the said operating position is arranged to run essentially vertically and be closed in its upper end, and in that an opening at the upper end of the cylindrical body is arranged to lead water vapour from the first space (110) to the container (131) for condensed water.

21. Device (100) according to claim 16, characterised in that the device comprises a valve (21) which limits the flow of condensed water out from the container (131) and thereby maintains an overpressure therein.

22. Device (100) according to claim 16, characterised in that the light is sunlight, which during operation is focused and conveyed into the optical fiber (12) at a location above the water body (50).

23. Device (100) according to claim 16, characterised in that the outlet (134) during operation is arranged to open out below the surface (51) of the water body (50).

24. Method for purifying water and transporting the purified water from its original location as a part of a body (50) of non-purified water and up from said water body to a desired delivery location (20) above the body, which method comprises the steps of
a) arranging an at least partly immersed, hollow structure, comprising a first space (110), a container (131) for condensed water comprising an outlet (134) arranged below a liquid level (132) in the container and a conduit device (120) running between the first space and the container via which the first space and the container freely can communicate;
b) to the first space supplying water to be purified and therein boil this water using light energy which is supplied through an optical fiber (12) to a certain heating location in the first space;
c) allowing the boiled off water vapour to rise upwards, through the conduit device, to a condenser (133) in which water vapour is condensed, and then collecting the condensed water in the container; and
d) tapping out condensed water through the outlet, for further transport to the delivery location;
characterised in that the first space is caused to freely communicate with the water body via a supply opening (112), as well as the combination of that firstly, the structure is caused to be closed except for the said supply opening and the outlet for condensed water, and, secondly, that the outlet for condensed water is caused to be arranged above the heating location, whereby the boiled off water vapour forms a gas column having sufficient vertical extension between the heating location and the outlet so that a surface (113) of non-purified water is formed, and so that the water pressure from the said surface on said gas column in combination with the steam pressure in the gas column itself gives rise to a pressure which is sufficient for pressing out the condensed water through the outlet and up to the delivery location using only its self pressure.

25. Method according to claim 24, characterised in that the condenser (133) is caused to be immersed into the water body (50), and in that the water vapour is cooled therein using the surrounding non-purified water.

26. Method according to claim 24, characterised in that the flow of condensed water out from the container (131) is caused to be regulated using a valve (21) which thereby maintains an overpressure in the container.

27. Method according to claim 24, characterised in that the light energy is caused to be achieved by focusing sunlight above the water body (50), which sunlight is thereafter led into an optical fiber (12) in turn conveying the sunlight on to the heating location in the first location (110).

28. Method according to claim 24, characterised in that the outlet (134) is caused to be arranged to open out below the surface (51) of the water body (50).

29. Method according to claim 24, characterised in that the water body (50) is arranged in a well, in that the purification of the water results in potable drinking water, and in that the desired delivery location (20) is arranged above ground.

30. Method according to claim 24, characterised in that the water body (50) is constituted by sea water, and in that the purification of the water comprises desalination.
